(19) United States
(12) Patent Application Publication
(10) Pub. No.: US 2026/0111734 A1
(43) Pub. Date: Apr. 23, 2026

(54) INDUSTRIAL TIME SERIES AIGC FUNDAMENTAL MODEL, ELECTRONIC DEVICE AND COMPUTER PROGRAM PRODUCT

(71) Applicant: BEIHANG UNIVERSITY, Beijing (CN)

(72) Inventors: Haiteng WANG, Beijing (CN); Lei REN, Beijing (CN); Yikang LI, Beijing (CN)

(73) Assignee: BEIHANG UNIVERSITY, Beijing (CN)

(21) Appl. No.: 19/211,931

(22) Filed: May 19, 2025

(30) Foreign Application Priority Data
Oct. 23, 2024 (CN) 202411480546.1

(51) Int. Cl. G06N 3/082; G06N 3/0455; G06N 3/048

(52) U.S. Cl. CPC G06N 3/082; G06N 3/0455; G06N 3/048

(57) ABSTRACT

An industrial time series AIGC fundamental model, an electronic device, and a computer program product. The model includes: an encoding module, configured to capture first relevant information of raw time series data in a frequency characteristic domain along a channel dimension, and downsample the first relevant information to obtain encoded time series data, where the raw time series data includes multiple types of raw vibration data, and each channel collects one type of raw vibration data; a decoding module, configured to capture second relevant information of the encoded time series data along a time dimension, and upsample the second relevant information to obtain decoded time series data; a synthesizing module, configured to synthesize the decoded time series data according to a trend and a time period respectively, and then perform concatenation processing to obtain the target time series data.

### CROSS-REFERENCE TO RELATED APPLICATION

This application claims priority to Chinese Patent Application No. 2024114805461, filed on Oct. 23, 2024, which is hereby incorporated by reference in its entirety.

### TECHNICAL FIELD

The present application relates to the field of time series technology and, in particular, to an industrial time series AIGC fundamental model, an electronic device, and a computer program product.

### BACKGROUND

With the continuous development of the industrial Internet, industrial enterprises collect a large amount of time series data during their production and operation processes. The time series data is processed in real time. The time series data refers to a sequence of data recorded in chronological order.

Existing industrial time series data is characterized by poor data quality, diverse types and significant noise. In the analysis of industrial time series data, current models ignore the diversity of frequency components. However, the fundamental industrial time series information resides in the frequency domain, such as the frequency of a vibration signal. Although the existing diffusion models can create time series, they mainly focus on the time domain and ignore the rich information in the frequency domain. As a result, the accuracy of extracted features is not high, making it difficult to generate high-fidelity predicted time series data.

### SUMMARY

Embodiments of the present application provide an industrial time series AIGC fundamental model, an electronic device, and a computer program product, for processing diverse raw time series data. Meanwhile, rich information in both time and frequency domains is leveraged to enhance the generation process of target time series data, thereby generating high-fidelity target time series data.

An embodiment of the present application provides an industrial time series AIGC fundamental model. The industrial time series AIGC fundamental model is used to process raw time series data from multiple channels to obtain target time series data. The industrial time series AIGC fundamental model includes: an encoding module, configured to capture first relevant information of the raw time series data in a frequency characteristic domain along a channel dimension, and downsample the first relevant information to obtain encoded time series data, where the raw time series data includes multiple types of raw vibration data, and each of the multiple channels collects a type of raw vibration data; a decoding module, configured to capture second relevant information of the encoded time series data along a time dimension, and upsample the second relevant information to obtain decoded time series data; a synthesizing module, configured to synthesize the decoded time series data according to a trend and a time period respectively, and then perform concatenation processing to obtain the target time series data.

An embodiment of the present application provides an electronic device. The electronic device includes a memory and a processor. The memory stores a computer-executable instruction and the processor executes the computer-executable instruction stored in the memory to: capture first relevant information of the raw time series data in a frequency characteristic domain along a channel dimension, and downsample the first relevant information to obtain encoded time series data, where the raw time series data includes multiple types of raw vibration data, and each of the multiple channels collects a type of raw vibration data; capture second relevant information of the encoded time series data along a time dimension, and upsample the second relevant information to obtain decoded time series data; synthesize the decoded time series data according to a trend and a time period respectively, and then perform concatenation processing to obtain the target time series data.

An embodiment of the present application provides a non-transitory computer-readable storage medium which stores a computer-executable instruction. A processor executes the computer-executable instruction to: capture first relevant information of the raw time series data in a frequency characteristic domain along a channel dimension, and downsample the first relevant information to obtain encoded time series data, where the raw time series data includes multiple types of raw vibration data, and each of the multiple channels collects a type of raw vibration data; capture second relevant information of the encoded time series data along a time dimension, and upsample the second relevant information to obtain decoded time series data; synthesize the decoded time series data according to a trend and a time period respectively, and then perform concatenation processing to obtain the target time series data.

An embodiment of the present application provides a computing system which includes one or more processors and one or more non-transitory computer-readable media that store the industrial time series AIGC fundamental model. The industrial time series AIGC fundamental model includes: an encoding module, configured to capture first relevant information of the raw time series data in a frequency characteristic domain along a channel dimension, and downsample the first relevant information to obtain encoded time series data, where the raw time series data includes multiple types of raw vibration data, and each of the multiple channels collects a type of raw vibration data; a decoding module, configured to capture second relevant information of the encoded time series data along a time dimension, and upsample the second relevant information to obtain decoded time series data; a synthesizing module, configured to synthesize the decoded time series data according to a trend and a time period respectively, and then perform concatenation processing to obtain the target time series data.

According to the industrial time series AIGC fundamental model, the electronic device, the non-transitory computer-readable storage medium and the computing system provided by the embodiments of the present application, the generation of the target time series data is along the channel dimension and the time dimension, and the synthesization is performed based on the trend and the time period. In this way, diverse raw time series data can be processed, and the generation process of the target time series data can be enhanced by leveraging rich information in both time and frequency domains, thereby generating high-fidelity target time series data.

### BRIEF DESCRIPTION OF DRAWINGS

The drawings herein are incorporated into and form a part of the specification, show embodiments consistent with the present application, and are used together with the specification to explain the rationale of the present application.

FIG. 1 is a flowchart of an industrial time series AIGC fundamental model provided by the present application.

FIG. 2 is a structural diagram I of an industrial time series AIGC fundamental model provided by the present application.

FIG. 3 is a structural diagram II of an industrial time series AIGC fundamental model provided by the present application.

FIG. 4 is a structure diagram of an encoding module provided by the present application.

FIG. 5 is a structure diagram of a decoding module provided by the present application.

FIG. 6 is a structure diagram of a mask processor provided by the present application.

FIG. 7 is a structure diagram of a synthesizing module provided by the present application.

FIG. 8 is an architecture diagram of an industrial time series AIGC fundamental model provided by the present application.

FIG. 9 is an architecture diagram of a synthesizing module provided by the present application.

FIG. 10 is a structure diagram of an electronic device provided by the present application.

Through the above drawings, clear embodiments of the present application have been shown, which will be described in more detail later. These drawings and written descriptions are not intended to limit the scope of the concept of the present application in any way, but to explain the concept of the present application to those skilled in the art by referring to specific embodiments.

### DETAILED DESCRIPTION OF EMBODIMENTS

Reference will now be made in detail to exemplary embodiments, examples of which are illustrated in drawings. When the description below relates to drawings, the same numbers in different drawings represent the same or similar elements unless otherwise indicated. The implementations described in the following exemplary embodiments do not represent all implementations consistent with the present application. Rather, they are merely examples of the apparatus and the method consistent with aspects of the present application as recited in the appended claims.

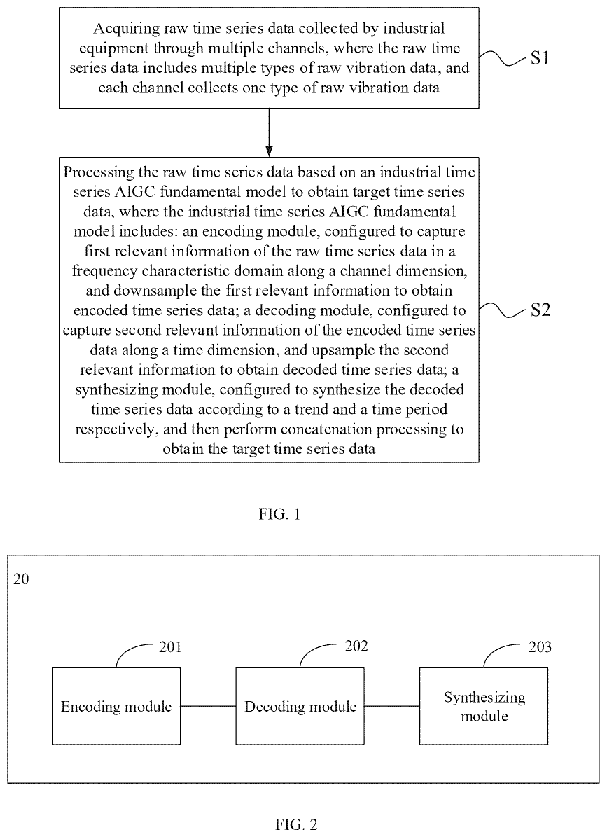

FIG. 1 is a flowchart of an industrial time series generation method provided by the present application. As shown in FIG. 1, the industrial time series generation method of the present application includes following steps.

Step S1: acquiring raw time series data collected by industrial equipment through multiple channels, where the raw time series data includes multiple types of raw vibration data, and each channel collects one type of raw vibration data.

In a possible implementation, the raw vibration data may be vibration data of the industrial equipment such as engines, bearings, and other machinery under various operating conditions. It is understood that the present application does not limit the specific source of the raw/original time series data.

Step S2: processing the raw time series data based on an industrial time series AIGC fundamental model to obtain target time series data, where the industrial time series AIGC fundamental model includes: an encoding module, configured to capture first relevant information of the raw time series data in a frequency characteristic domain along a channel dimension, and downsample the first relevant information to obtain encoded time series data; a decoding module, configured to capture second relevant information of the encoded time series data along a time dimension, and upsample the second relevant information to obtain decoded time series data; a synthesizing module, configured to synthesize the decoded time series data according to a trend and a time period respectively, and then perform concatenation processing to obtain the target time series data. After obtaining the target time series data, one or more production optimization strategies can be formulated and/or product quality can be evaluated based on the target time series data.

Artificial Intelligence Generated Content (AIGC) refers to a technology that generates relevant content with appropriate generalization ability by learning and identifying the distribution of existing industrial data based on artificial intelligence techniques such as diffusion models. The meaning of “fundamental” in the industrial time series AIGC fundamental model means that the model serves as a core framework, based on which diverse and multi-frequency target time series data can be can generated, and it also has the ability to adapt to different industrial application scenarios.

According to the industrial time series AIGC fundamental model provided by the present application, the generation of the target time series data is along the channel dimension and the time dimension, and the synthesization is performed based on the trend and the time period. In this way, diverse raw time series data can be processed, and the generation process of the target time series data can be enhanced by leveraging rich information in both time and frequency domains, thereby generating high-fidelity target time series data.

Technical solutions of the present application and how the technical solutions of the present application solve the above-mentioned technical problems are described in detail below with specific embodiments. The following specific embodiments may be combined with each other, and the same or similar concepts or processes may not be described in detail in some embodiments. The embodiments of the present application will be described below in conjunction with drawings.

FIG. 2 is a structural diagram I of an industrial time series AIGC fundamental model provided by the present application. As shown in FIG. 2, the industrial time series AIGC fundamental model 20 provided in this embodiment includes:
an encoding module 201, configured to capture first relevant information of the raw time series data in a frequency characteristic domain along a channel dimension, and downsample the first relevant information to obtain encoded time series data;
a decoding module 202, configured to capture second relevant information of the encoded time series data along a time dimension, and upsample the second relevant information to obtain decoded time series data;
a synthesizing module 203, configured to synthesize the decoded time series data according to a trend and a time period respectively, and then perform concatenation processing to obtain the target time series data.

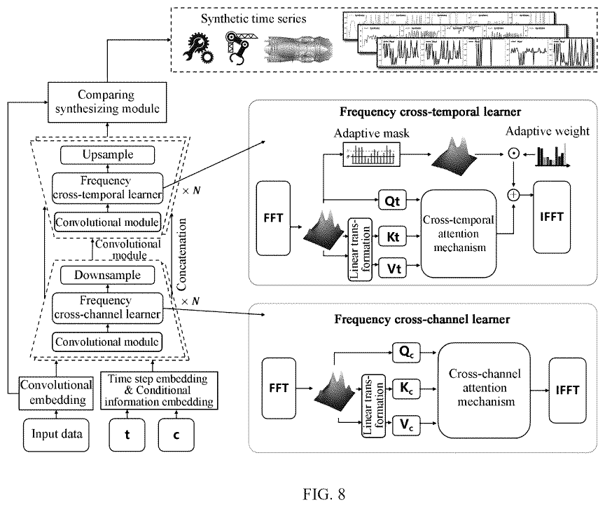

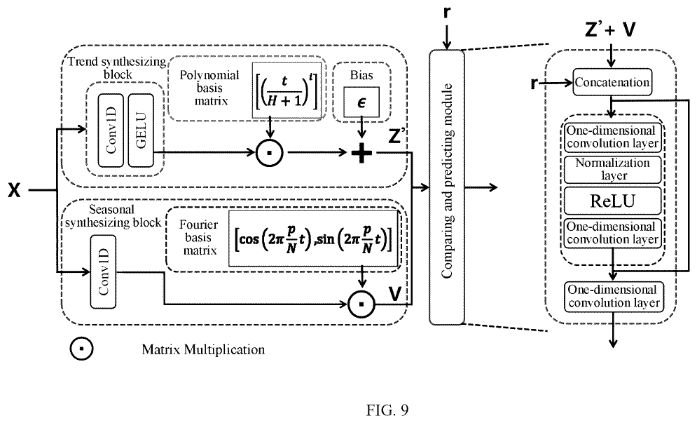

In a possible implementation, the number of the encoding module and the number of the decoding module of the present application may be N. N is a natural number. FIG. 8 is an architecture diagram of an industrial time series AIGC fundamental model provided by the present application, FIG. 9 is an architecture diagram of a synthesizing module provided by the present application. In order to better describe an industrial time series AIGC fundamental model provided by this embodiment, in the following, description will be made in conjunction with FIG. 8 and FIG. 9.

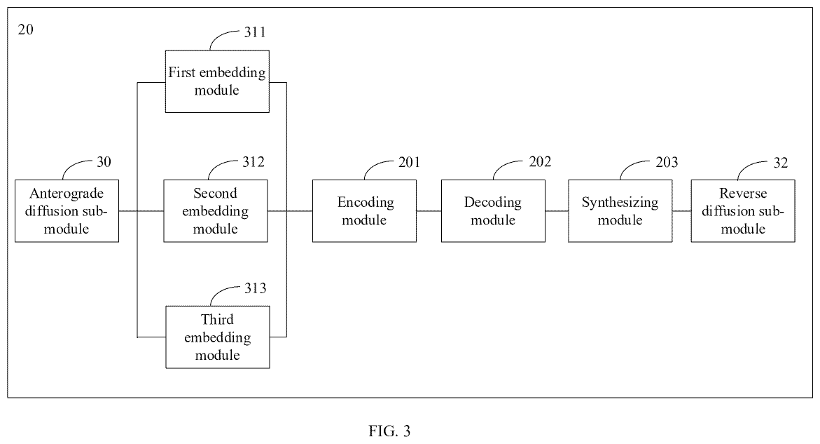

FIG. 3 is a structural diagram II of an industrial time series AIGC fundamental model provided by the present application. As shown in FIG. 3, the industrial time series AIGC fundamental model 20 provided in this embodiment further includes a diffusion module, and the diffusion module includes an anterograde diffusion sub-module 30. The anterograde diffusion sub-module 30 is configured to add preset noise to the raw time series data according to a preset diffusion time step to obtain diffused raw time series data.

The industrial time series AIGC fundamental model of the present application is a fundamental model generated based on a diffusion probability architecture and is designed for the generation of industrial time series. The diffusion module is capable of estimating the distribution of training samples and extract effective data representations from the distribution, thereby modeling complex patterns in time series and supporting a wide range of downstream tasks. In the context of modeling, diffusion is a process in which particles or information may spread from areas of high concentration to areas of low concentration over time, eventually reaching a state of equilibrium.

In a possible implementation, a diffusion process of the present application includes two main stages: forward diffusion and reverse diffusion. Forward diffusion is the stage of adding noise, also known as anterograde diffusion. Reverse diffusion is the stage for removing noise.

In the forward diffusion process, the raw time series data X₀ follows the distribution q(X₀), and in each step of the forward diffusion, Gaussian noise is iteratively added on the basis of Xₜ₋₁ which is from the previous step. Forward diffusion can be mathematically described using the iterative process represented by the following formula (1):

$$q ( {x}_{t} \vert {x}_{t - 1} ) = N ( {x}_{t} \text{?} \sqrt{{a}_{t}} {x}_{t - 1} , ( 1 - {a}_{t} ) \text{?} ) \qquad Formula ( 1 )$$

$$\text{?} \text{indicates text missing or illegible when filed}$$

Xₜ represents the noise data when the time step is t, that is, the diffused raw time series data; aₜ is a parameter that controls the amount of noise added at each step, N represents a normal distribution. At the end of the anterograde diffusion process, raw time series data is heavily corrupted by noise and converted to a distribution closer to the standard Gaussian distribution.

In a possible implementation, as shown in FIG. 3, the industrial time series AIGC fundamental model further includes an embedding module, the embedding module includes:
a first embedding module 311, configured to perform latent variable embedding on the diffused raw time series data using one-dimensional convolution, to obtain embedded time series data after embedding;
a second embedding module 312, configured to perform embedding on a discrete diffusion time step using sine positional embedding and a fully connected layer, to obtain continuous time feature information;
a third embedding module 313, configured to perform embedding on preset condition information using a masked fully connected layer, to obtain vector condition information represented as a vector, where the condition information includes condition(s) for constraining a range of the embedded time series data.

The latent variable refers to parameter(s) that cannot be directly and accurately observed or that can be observed but still needs to be integrated through other methods. In order to process the latent variable, diffusion time step and conditional information to preserve temporal relationships and conditional information, the present application uses an embedding module to perform embedding transformation for each input. In FIG. 8, the embedding module includes convolutional embedding, time step embedding, and conditional information embedding.

In a possible implementation, the first embedding module performs latent variable embedding using one-dimensional convolution to obtain the embedded time series Xₜ_{_{emb}}:

$${x}_{{t}_{emb}} = Conv 1 D ( {x}_{t} ) \qquad Formula ( 2 )$$

Xₜ_{_{emb}} is the embedded time series data after embedding.

For the diffusion time step t, as shown in formulas (3) and (4), the second embedding module performs embedding using sine positional embedding PosEmbed(⋅) and the fully connected layer FC(⋅), to convert the discrete diffusion time step t into continuous time feature information t_{emb}

$${t}_{pos} = PosEmbed ( t ) \qquad Formula ( 3 )$$

$${t}_{emb} = FC ( GeLU ( FC ( {t}_{pos} ) ) ) \qquad Formula ( 4 )$$

tₚₒₛ represents time encoding, and GeLU represents an activation function.

For the preset conditional information x_{c}, the third embedding module performs embedding using a masked FC network, to convert the conditional information into a vector representation:

$${x}_{{c}_{emb}} = FC ( {x}_{c} ) \qquad Formula ( 5 )$$

X_{C}_{_{emb}} is the vector condition information represented as vector.

The industrial time series AIGC fundamental model of the present application adopts a structure similar to Unet to generate target time series data. The main architecture of the industrial time series AIGC fundamental model includes an encoding module, a decoding module and a synthesizing module, which are designed to capture and reconstruct time series data.

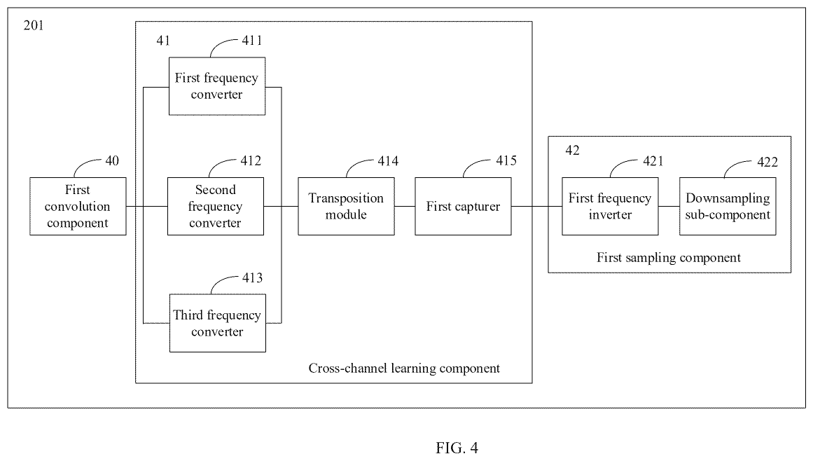

FIG. 4 is a structure diagram of an encoding module provided by the present application. As shown in FIG. 4, the encoding module 201 provided in this embodiment includes:
a first convolution component 40, configured to encode the raw time series data through multiple encoder layers to obtain first intermediate data, where the first intermediate data includes encoded intermediate time series data, continuous time feature information, and vector condition information;
a cross-channel learning component 41, configured to process the first intermediate data in the frequency characteristic domain along the channel dimension to obtain the first relevant information;
a first sampling component 42, configured to perform downsampling processing on the first relevant information to obtain the encoded time series data.

In a possible implementation, the first convolution component includes at least two convolution layers, and the convolution layer includes multiple encoder layers for encoding the entire embedded time series data. The continuous time feature information and the vector condition information may also be input into each convolutional layer and encoded together with the embedded time series data to retain diffusion steps and condition information.

In related art, it is difficult for models to learn column correlations of multiple channels. Different from continuous pixel values in images, dimensions in industrial time series data represent different variables, each of the variables has a unique meaning. These data involve multiple variables with complex interdependencies, making it difficult to learn joint probabilities among these variables.

Therefore, it is crucial to consider the dependencies of channels in the process of generating target time series data. The present application proposes a cross-channel learning component, which promotes communication between different channels by adopting a frequency cross-channel attention mechanism at each time step, thereby achieving learning of the relevance between multiple channels.

In a possible implementation, the cross-channel learning component 41 is a frequency cross-channel learner in FIG. 8. As shown in FIG. 4, the cross-channel learning component 41 includes:
a first frequency converter 411, configured to convert the first intermediate data along a time step dimension to a frequency domain via fast Fourier transform to obtain a first query vector;
a second frequency converter 412, configured to perform fast Fourier transform on a product of the first intermediate data and a preset first key vector weight matrix to obtain a first key vector;
a third frequency converter 413, configured to perform fast Fourier transform on a product of the first intermediate data and a preset first value vector weight matrix to obtain a first value vector;
a transposition module 414, configured to transpose the first query vector, the first key vector, and the first value vector, respectively, to obtain a transposed second query vector, a transposed second key vector, and a transposed second value vector, respectively;
a first capturer 415, configured to capture the first relevant information in the frequency characteristic domain along the channel dimension according to the transposed second query vector, the transposed second key vector and the transposed second value vector.

In a possible implementation, the first intermediate data is converted to the frequency domain along the time step dimension via fast Fourier transform, to obtain the first query vector. This process is also called a frequency conversion process. Specifically, the first intermediate data input is transformed into the frequency domain via fast Fourier transform (FFT) along the time step dimension to capture global frequency information, as shown in formula (6):

$${X}_{FFT} = FFT ( {X}_{en}^{i} ) \qquad Formula ( 6 )$$

$${X}_{FFT} ∈ ℂ \text{?}$$

$$\text{?} \text{indicates text missing or illegible when filed}$$

represents the global frequency information, that is, the first query vector. T is the number of time steps of each time series, and C is the number of channels.

$${X}_{e n}^{i} ∈ {T \times C}^{}$$

represents the first intermediate data input by the iₜₕ encoder layer. In this way, the industrial time series AIGC fundamental model is capable of analyzing periodic patterns and frequency components.

In a possible implementation, in a self-attention mechanism, the first query vector Q is used to ask questions, the first key vector K represents features to be matched, and the first value vector V represents the corresponding information. In the cross-channel learning component, the first key vector and the first value vector are defined in the following formulas:

$$K = FFT ( {W}_{K} {X}_{e n}^{i} ) \qquad Formula ( 7 )$$

$$V = FFT ( {W}_{V} {X}_{e n}^{i} ) \qquad Formula ( 8 )$$

W_{K} is the preset first key vector weight matrix, W_{V} is the preset first value vector weight matrix, both of which are learnable weight matrices.

After conversion to the frequency domain, as shown in formular (9) of the series of formulas, the first query vector Q, the first key vector K and the first value vector V are transposed to obtain the transposed second query vector Q_{c}, the transposed second key vector K_{c} and the transposed second value vector V_{c} to focus on the channel dimension:

$${Q}_{c} = {Q}^{T} , {K}_{c} = {K}^{T} , {V}_{c} = {V}^{T} \qquad Formula ( 9 )$$

Then, multivariate correlation modeling is performed using the cross-channel learning component, and the frequency cross-channel attention mechanism is used to capture the dependencies between different channels along the channel dimension in the frequency characteristic domain:

$${FreqAtte𝔫}_{chan} ( {Q}_{c} , {K}_{c} , {V}_{c} ) = {Softmax}_{chan} ( \frac{{Q}_{c} {K}_{C}^{T}}{\sqrt{{d}_{k}}} ) {V}_{c} \qquad Formula ( 10 )$$

dₖ is the dimension of the vector K_{c}, Softmax_{chan}(⋅) represents the application of the softmax function along the channel dimension to normalize attention weights, so that the network can emphasize the influence of different channels and learn multi-channel relevance in the frequency characteristic domain, and FreqAtten_{chan} (Q_{c}, K_{c}, V_{c}) is the first relevant information.

In a possible implementation, as shown in FIG. 4, the first sampling component 42 includes:
a first frequency inverter 421, configured to map the first relevant information back to a original time series domain via inverse fast Fourier transform to obtain first to-be-sampled time series data;
a downsampling sub-component 422, configured to perform downsampling processing on the first to-be-sampled time series data to obtain the encoded time series data.

In a possible implementation, the first relevant information is a frequency attention vector

$${X}_{a t t}^{i} .$$

By mapping the first relevant information back to the original time series domain using the inverse fast Fourier transform, the first to-be-sampled time series data is obtained for further downsampling processing. As shown in the following formula (11):

$${X}_{c h a n}^{i} = IFFT ( {X}_{a t t}^{i} ) \qquad Formula ( 11 )$$

$${X}_{c h a n}^{i}$$

is the first to-be-sampled time series data.

The downsampling sub-component may be a ½ downsampling block. Performing downsampling processing on the first to-be-sampled time series data to obtain the encoded time series data, as shown in the following formula (12):

$${X}_{e n}^{i + 1} = DownSample ( {X}_{c h a n}^{i} ) \qquad Formula ( 12 )$$

$${X}_{en}^{i + 1}$$

is the encoded time series data.

The decoding module of the present application includes a cross-temporal learning component, which uses Fourier domain and the cross-temporal-spatial attention mechanism to capture long-distance dependencies and complex patterns that are difficult to be identified in a time domain.

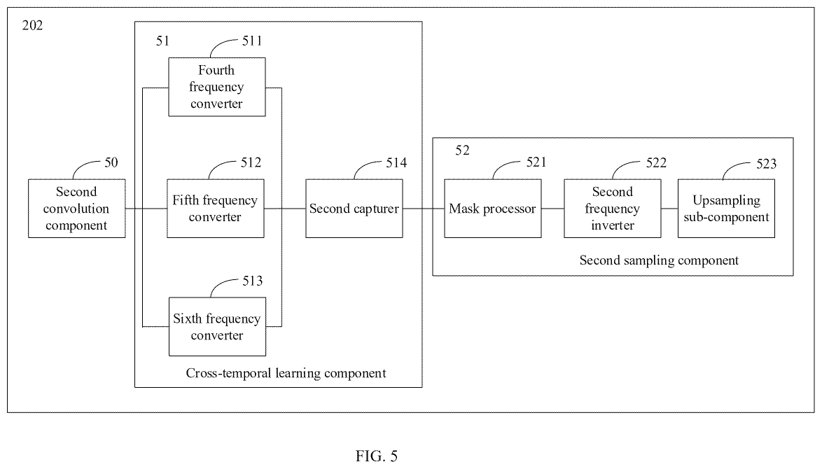

FIG. 5 is a structure diagram of a decoding module provided by the present application. As shown in FIG. 5, the decoding module 202 provided in this embodiment includes:
a second convolution component 50, configured to decode the encoded time series data by multiple decoder layers to obtain second intermediate data;
a cross-temporal learning component 51, configured to process the second intermediate data along the time dimension to obtain the second relevant information of the encoded time series data;
a second sampling component 52, configured to perform upsampling processing on the second relevant information to obtain the decoded time series data.

In a possible implementation, the second convolution component includes at least two convolution layers. The convolution layer includes multiple decoder layers for decoding the entire encoded time series data. Each decoder layer may correspond to one encoder layer. The decoding module is capable of enhancing details and restoring a signal to its original size. An intermediate convolution block may also be provided between the encoding module and the decoding module to act as a bridge, and may extract abstract features between the encoder and decoder stages.

In a possible implementation, the cross-temporal learning component 51 is a frequency cross-temporal learner in FIG. 8. As shown in FIG. 5, the cross-temporal learning component 51 includes:
a fourth frequency converter 511, configured to convert the second intermediate data along the time dimension to the frequency domain via fast Fourier transform to obtain a third query vector;
a fifth frequency converter 512, configured to perform fast Fourier transform on a product of the second intermediate data and a preset third key vector weight matrix to obtain a third key vector;
a sixth frequency converter 513, configured to perform fast Fourier transform on a product of the second intermediate data and a preset third value vector weight matrix to obtain a third value vector;
a second capturer 514, configured to capture the second relevant information of the encoded time series data along the time dimension according to the third query vector, the third key vector and the third value vector.

In a possible implementation, the present application proposes a frequency cross-temporal-spatial attention mechanism to adaptively select important information cross time and space dimensions. This method is similar to the frequency cross-channel attention mechanism, it applies FFT and linear transformation on a query matrix, a key matrix and a value matrix, but does not transpose an attention matrix, instead, it focuses on the time dimension.

In a possible implementation, the second intermediate data is converted along the time dimension to the frequency domain via fast Fourier transform to obtain the third query vector Qₜ, as shown in formula (13):

$${Q}_{t} = FFT ( {X}_{d e}^{i} ) \qquad Formula ( 13 )$$

$${X}_{de}^{i} ∈ {T \times C}^{}$$

represents the input of the iₜₕ decoder layer, which is the second intermediate data.

In a possible implementation, in the cross-temporal learning component, the third key vector and the third value vector are defined as follows:

$${K}_{t} = FFT ( {{W}_{K}}^{′} {X}_{d e}^{i} ) \qquad Formula ( 14 )$$

$${V}_{t} = FFT ( {{W}_{V}}^{′} {X}_{d e}^{i} ) \qquad Formula ( 15 )$$

W_{K}′ is the preset third key vector weight matrix, W_{V}′ is the preset third value vector weight matrix, both of which are learnable weight matrices.

Then, the second relevant information of the encoded time series data is captured along the time dimension, as shown in formula (16):

$${FreqAtte𝔫}_{chan} ( {Q}_{t} , {K}_{t} , {V}_{t} ) = {Softmax}_{time} ( \frac{{Q}_{t} {K}_{t}^{T}}{\sqrt{{d}_{k}}} ) {V}_{t} \qquad Formula ( 16 )$$

The third query vector Qₜ, the third key vecto Kₜ and the third value vector Vₜ represent a cross-temporal attention matrix in the frequency domain. Different from the frequency cross-channel attention mechanism, the frequency cross-temporal attention mechanism Softmaxₜᵢₘₑ(⋅) uses a softmax function in the time dimension. This attention mechanism operates at different time steps, enabling the model of the present application to capture long-range dependencies and dynamic patterns at different time steps.

In a possible implementation, as shown in FIG. 5, the second sampling component 52 includes:
a mask processor 521, configured to perform adaptive high frequency mask processing on the third query vector to obtain a frequency enhancement parameter;
a second frequency inverter 522, configured to map a sum of the second relevant information and the frequency enhancement parameter back to the original time series domain via inverse fast Fourier transform, to obtain second to-be-sampled time series data;
an upsampling sub-component 523, configured to perform upsampling processing on the second to-be-sampled time series data to obtain the decoded time series data.

In a possible implementation, the mask processor adopts the adaptive high-frequency masking solution proposed in the present application, allowing the industrial time series AIGC fundamental model to dynamically adjust the filtering level and remove high-frequency noise components.

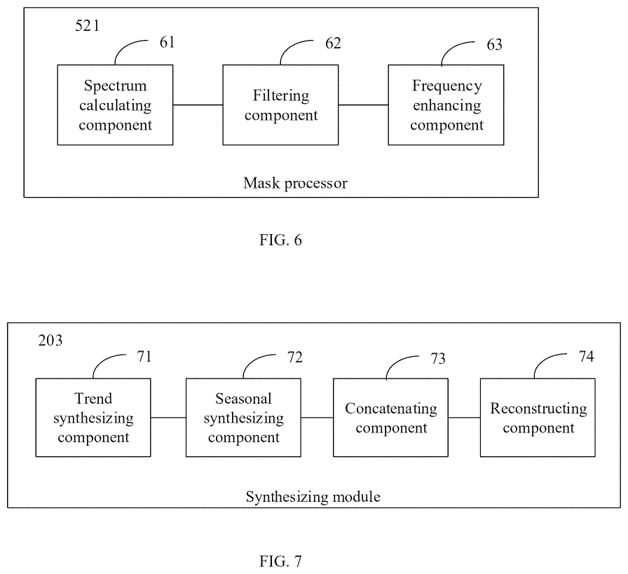

FIG. 6 is a structure diagram of a mask processor provided by the present application. As shown in FIG. 6, the mask processor 521 provided in this embodiment includes:
a spectrum calculating component 61, configured to calculate a spectrum representing an intensity of each time series frequency according to the third query vector;
a filtering component 62, configured to normalize the spectrum and filter out a frequency component which is below a preset training threshold to obtain a filtered spectrum;
a frequency enhancing component 63, configured to obtain a frequency enhancement parameter according to the filtered spectrum and a preset adaptive weight.

In a possible implementation, the present application proposes an adaptive filtering mechanism to further improve the ability of the industrial time series AIGC fundamental model to focus on important frequency components while reducing noise. First, the spectrum which represents the intensity of each time series frequency is calculated as follows:

$${X}_{SP} = {\vert {X}_{FFT} \vert}^{2} \qquad Formula ( 17 )$$

X_{FFT} is the third query vector, and X_{SP} is the spectrum representing the intensity of each time series frequency, also known as the power spectrum, it represents the intensity of each time series frequency.

In a possible implementation, the spectrum is subject to the normalization processing. Frequency components which are below the preset training threshold are filtered out to obtain a filtered spectrum. For example, the spectrum is normalized and compared with a learnable threshold θ that is automatically optimized via back-propagation

$$\frac{\partial Loss}{\partial θ}$$

during training. The spectrum below the threshold θ can be filtered out to reduce noise interference.

In a possible implementation, the filtered frequency components are enhanced by an adaptive learnable weight. The overall process can be expressed as:

$${X}_{filtered} = {X}_{FFT} ⊙ Mask ( {X}_{SP} < θ ) \qquad Formula ( 18 )$$

$${X}_{enhanced} = {X}_{filtered} ⊙ {W}_{ada} \qquad Formula ( 19 )$$

⊙ represents element-wise multiplication, Mask represents a mask. In the formula (18), the frequencies in the spectrum which are below the threshold are selectively filtered out. X_{filtered} is the filtered spectrum. W_{ada} represents the adaptive learnable weight that can selectively enhance important frequency component(s), and X_{enhanced} is a frequency enhancement parameter.

In a possible implementation, the second frequency inverter maps the sum of the second relevant information and the frequency enhancement parameter back to the original time series domain via inverse fast Fourier transform (IFFT) to obtain the second to-be-sampled time series data. The frequency enhancement parameter X_{enhanced} and the frequency attention vector

$${X}_{att}^{j}$$

obtained from the frequency cross-temporal attention mechanism are converted back to the time domain using IFFT:

$${X}_{t i m e}^{i} = IFFT ( {X}_{a t t}^{i} + {X}_{e n h a n c e d} ) \qquad Formula ( 20 )$$

$${X}_{t i m e}^{i}$$

is the second to-be-sampled time series data.

The upsampling sub-component may be a 2× upsampling block. The second to-be-sampled time series data is upsampled to obtain the decoded time series data, as shown in the following formula (21):

$${X}_{de}^{i + 1} = UpSample ( {X}_{time}^{i} ) \qquad Formula ( 21 )$$

$${X}_{t i m e}^{i}$$

is the decoded time series data.

In related art, models have difficulty in capturing complex temporal dynamic patterns. Industrial time series data is collected from physical equipment and reflects the dynamic details of the equipment as affected by the real environment and its performance over time. These data include long-term degradation processes and short-term dynamic changes, such as temperature and pressure fluctuations, which make it difficult for diffusion models designed for static images to effectively synthesize industrial time series.

Therefore, the present application also provides a synthesizing module to generate target time series data, namely a comparing and synthesizing module of FIG. 8, which can synthesize trend and seasonal information to reconstruct the time series, and perform denoising based on the initial input to finally generate high-fidelity time series data. By adopting a deep decomposition model architecture for comparison and synthesis, the generated time series can synthesize both long-term degradation information and short-term detail information, thereby promoting the accurate reproduction of the temporal dynamics of the data during the generation process.

FIG. 7 is a structure diagram of a synthesizing module provided by the present application. As shown in FIG. 7, the synthesizing module 203 provided in this embodiment includes:
a trend synthesizing component 71, configured to synthesize the decoded time series data according to the trend to obtain a first time series feature matrix;
a seasonal synthesizing component 72, configured to synthesize the decoded time series data according to the time period to obtain a second time series feature matrix;
a concatenating component 73, configured to add the first time series feature matrix and the second time series feature matrix and then concatenate a result of the addition with the raw time series data to obtain concatenated time series data;
a reconstructing component 74, configured to perform deep processing and reconstruction on the concatenated time series data through a residual block, to obtain the target time series data, where the residual block consists of a multi-layer convolution operation and a non-linear activation function.

In a possible implementation, the trend synthesizing component 71 is a trend synthesizing block of FIG. 9. In this embodiment, polynomial regression may be used for trend synthesis. Polynomial regression allows the use of higher-order polynomials to model complex trends, so a polynomial regression-based approach is used as the trend synthesizing component to synthesize slowly changing long-term trend information.

A polynomial regression model can be based on a linear regression model y=x^{T}β+ϵ, in which an input feature x is expanded into a polynomial basis matrix P, and a polynomial basis is weighted by using a feature map Z of the input data instead of a regression coefficient β, so that the model can capture nonlinear trends.

Specifically, the polynomial regression model can be expressed as:

$${Z}^{′} = Z \cdot P + ϵ \qquad Formula ( 22 )$$

$${P}_{i} = [ {( \frac{1}{H + 1} )}^{i} , {( \frac{2}{H + 1} )}^{i} , … , {( \frac{H}{H + 1} )}^{i} ] \qquad Formula ( 23 )$$

$$Z = GELU ( Conv 1 d ( X ) ) \qquad Formula ( 24 )$$

ϵ is bias, P is a polynomial basis space matrix, Pᵢ is the iₜₕ row of the matrix P, and H is a preset normalization parameter, Z′ is the first time series feature matrix.

Normalizing the time step t to

$$\frac{t}{H + 1}$$

allows the features to be on a uniform scale, ensuring that the features have a relatively consistent range across different time steps, avoiding the negative impact of extremely large or small values on model training.

In a possible implementation, the feature map Z is a local feature of the input data, and is obtained by performing one-dimensional convolution and GELU nonlinear transformation on input data X. The feature map Z′ is the first time series feature matrix, and the input data X is the raw time series data.

In the polynomial regression model, the feature map Z acts as a feature matrix and the basis space P provides polynomial features, this combination actually applies weighting similar to regression coefficients based on the feature map. The model compares the predicted trend value with the actual trend value, calculates the loss and back-propagates, and continuously adjusts the convolution kernel weights and bias terms, so that the feature map Z′ can better capture the effective features of the input data and adjust the weighting parameters, thereby achieving optimal modeling of the trend of time series data.

In time series analysis, seasonality refers to recurrence of periodic patterns in the data. The seasonal synthesizing component 72 is a seasonal synthesizing block of FIG. 9. To model these seasonal patterns, the present application uses a Fourier series modeling method to decompose complex time series into a series of simple sine and cosine functions. The basic structure includes a convolutional layer and a Fourier transform layer.

The convolution layer extracts a feature matrix S from input time series data by performing a one-dimensional convolution operation on the input data X.

$$S = GELU ( Conv 1 d ( X ) ) \qquad Formula ( 25 )$$

In order to transform the output of the convolutional layer as weighted coefficients into Fourier space, the Fourier basis function is defined as follows:

$${F}_{cos} = [ cos ( 2 π \frac{p}{out\_dim} t ) \vert p ∈ [ 1 , {P}_{1} ] ] \qquad Formula ( 26 )$$

$${F}_{sin} = [ sin ( 2 π \frac{p}{out\_dim} t ) \vert p ∈ [ 1 , {P}_{2} ] ] \qquad Formula ( 27 )$$

$$F = [ {F}_{cos} , {F}_{sin} ] \qquad Formula ( 28 )$$

P₁ and P₂ represent the number of sine basis functions and the number of cosine basis functions respectively, and a Fourier basis matrix F is obtained by combining the sine basis function Fₛᵢₙ and the cosine basis function F_{cos}.

Then, the feature matrix output by the convolutional layer as the weighted coefficients of different sine and cosine basis functions is multiplied with the Fourier basis matrix to obtain a similar periodic function, thus realizing modeling of the seasonal component in the time series data:

$${V}_{seas}^{t} = S \cdot F \qquad Formula ( 29 )$$

$${V}_{seas}^{t}$$

is the second time series feature matrix.

The seasonal synthesizing component compares the predicted seasonal component with the actual seasonal component, calculates the loss and back-propagates, and continuously adjusts convolution kernel weights and bias terms so that the feature matrix S can better capture the periodic characteristics of the input data, thereby adjusting the weighting coefficients of different frequency components to achieve optimal modeling of the seasonal component.

Without considering the noise information, relying solely on trend and seasonal components for forecasting may cause the recovered time series to be different from the raw series. To address this problem, the present application designs and introduces a comparative prediction function to enhance the ability of the model in noise prediction.

In a possible implementation, the concatenating component is a comparing and predicting module and a concatenating part of FIG. 9. Specifically, the feature x processed by the trend synthesizing component and the seasonal synthesizing component is concatenated with an original input signal r as shown in formula (30). The feature processed by the trend synthesizing component and the seasonal synthesizing component is Z+V, and the original input signal r is the raw time series data. Combining the generated features with the original signal enables the industrial time series AIGC fundamental model to directly compare the differences between the synthesized time series and the original series.

$${x}_{cat} = concat ( x , r ) \qquad Formula ( 30 )$$

concat(⋅) represents the concatenation of two feature tensors in a specific dimension.

Subsequently, the concatenated feature X_{cat} is deeply processed and reconstructed through a residual block. The residual block consists of the multi-layer convolution operation W and the nonlinear activation function RELU to extract and enhance a noise component z in the feature.

$$z = RELU ( W * {x}_{cat} ) \qquad Formula ( 31 )$$

The concatenated feature is input into a convolutional layer, which can map a high-dimensional abstract feature to a target output dimension. For example, the convolution layer in FIG. 9 is a one-dimensional convolution layer. Moreover, through the convolution operation, the industrial time series AIGC fundamental model converts the extracted feature into an actual noise prediction value and makes the dimension of output data match the dimension of the input data.

In a possible implementation, as shown in FIG. 3, the diffusion module further includes:
a reverse diffusion sub-module 32, configured to acquire target noise of the target time series data, and perform denoising processing on the raw time series data based on the target noise to obtain predicted time series data.

Back diffusion process aims to denoise the data step by step and recover the raw time series data from noisy observation data using the target noise.

The denoising model of the present application can iteratively remove the added noise. The back diffusion process can be described with the following denoising steps:

$${p}_{θ} ( {x}_{t - 1} \vert {x}_{t} ) = N ( {x}_{t - 1} ; {μ}_{θ} ( {x}_{t} , t ) , {Σ}_{θ} ( {x}_{t} , t ) ) \qquad Formula ( 32 )$$

μᵢⱼ and Σᵢⱼ are the mean and variance of the denoising model predictions at each step t. The denoising model with the preset θ as its parameter estimates these parameters through learning, thereby gradually removing the noise and reconstructing the raw data to obtain the predicted time series data.

An electronic device provided in this embodiment can execute the method provided in the above method embodiments, and its implementation principle and technical effect are similar, and will not be described in detail here.

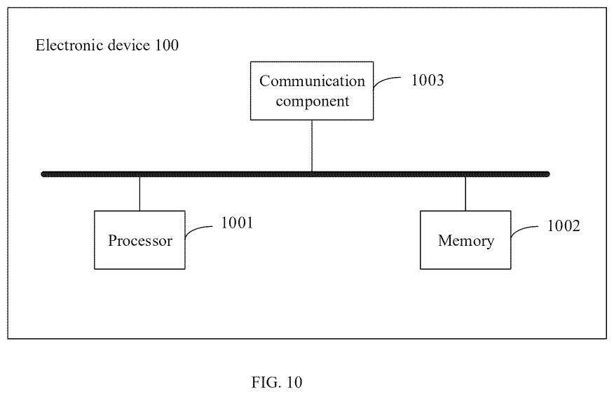

FIG. 10 is a structure diagram of an electronic device provided by the present application. As shown in FIG. 10, the electronic device 100 provided in this embodiment includes: at least one processor 1001 and a memory 1002. In an implementation, the device 100 further includes a communication component 1003. The processor 1001, the memory 1002 and the communication component 1003 are connected via a bus 1004.

In a specific implementation, the at least one processor 1001 executes a computer-executable instruction stored in the memory 1002, so that the at least one processor 1001 executes the above method.

For the specific implementation process of the processor 1001, reference can be made to the above method embodiment. Its implementation principle and technical effect are similar, and will not be repeated here.

In the above embodiments, it should be understood that the processor may be a central processing unit (CPU), or other general-purpose processors, a digital signal processor (DSP), an application specific integrated circuit (ASIC), etc. The general purpose processor may be a microprocessor or any conventional processor or the like. The steps of the method disclosed in the present application can be directly implemented using a hardware processor, or can be implemented using a combination of hardware and software modules in the processor.

The memory may include a high-speed memory (Random Access Memory, RAM), or may also include a non-volatile memory (NVM), such as at least one disk storage.

The bus can be an industry standard architecture (ISA) bus, a peripheral component interconnect (PCI) bus, or an extended industry standard architecture (EISA) bus, etc. The bus can be an address bus, a data bus, a control bus, etc. For ease of representation, the bus in the drawings of the present application is not limited to only one bus or one type of bus.

The present application also provides a computer program product. The computer program product includes a computer program. When the computer program product is executed by processor, the above method is implemented.

The present application also provides a computer-readable storage medium, in which a computer-executable instruction is stored. When a processor executes the computer-executable instruction, the above method is implemented.

The above-mentioned readable storage medium can be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic storage, a flash memory, a magnetic disk or an optical disk. Readable storage media can be any available media that can be accessed by a general purpose or special purpose computer.

An exemplary readable storage medium is coupled to the processor, so that the processor can read information from and write information to the readable storage medium. Of course, the readable storage medium may also be an integral part of the processor. The processor and the readable storage medium may be located in an application specific integrated circuit (ASIC). Of course, the processor and the readable storage medium may also exist in the device as discrete components.

The division of units is only a logical function division. There may be other division methods in actual implementation. For example, multiple units or components can be combined or integrated into another system, or some features can be ignored or not executed. Another point is that the mutual coupling or direct coupling or communication connection shown or discussed may be an indirect coupling or communication connection through some interfaces, devices or units, which may be electrical, mechanical or other forms.

The units described as partitioning components may or may not be physically separated, and the components shown as units may or may not be physical units, that is, they may be located in one place or distributed over multiple network units. Some or all of the units may be selected according to actual needs to achieve the purpose of the solution in the embodiments.

In addition, each functional unit in each embodiment of the present invention may be integrated into one processing unit, or each unit may exist physically separately, or two or more units may be integrated into one unit.

If the functions are implemented in the form of software functional units and sold or used as independent products, they can be stored in a computer-readable storage medium. Based on such understanding, the technical solution of the present invention, or the part that contributes to the prior art, or the part of the technical solution, can be embodied in the form of a software product. The computer software product is stored in a storage medium and includes a number of instructions for enabling a computer device (which can be a personal computer, a server, or a network device, etc.) to perform all or part of the steps of the methods of each embodiment of the present invention. The aforementioned storage media include: an USB flash drive, a mobile hard disk, a read-only memory (ROM), a random access memory (RAM), a magnetic disk or an optical disk, and other media that can store program codes.

Those skilled in the art can understand that all or part of the steps of implementing the above method embodiments may be completed by hardware associated with program instructions. The aforementioned program may be stored in a computer-readable storage medium. When the program is executed, the steps of the above-mentioned method embodiments are executed, and the aforementioned storage medium includes: a ROM, a RAM, a magnetic disk or an optical disk and other media that can store program codes.

Finally, it should be noted that other embodiments of the present invention will be apparent to those skilled in the art from consideration of the specification and practice of the invention disclosed herein. The present invention is intended to cover any variations, uses or adaptive changes of the present invention. Those variations, uses or adaptive changes follow the general principles of the present invention and include common knowledge or customary technical means in the technical field not disclosed by the present invention. These aspects are not limited to the precise structure described above and shown in the drawings, and various modifications and changes may be made without departing from the scope thereof. The scope of the present invention is limited only by the appended claims.

What is claimed is:

1. An industrial time series artificial intelligence generated content (AIGC) fundamental model, wherein the industrial time series AIGC fundamental model is used to process raw time series data from multiple channels to obtain target time series data, and the industrial time series AIGC fundamental model comprises:
an encoding module configured to capture first relevant information of the raw time series data in a frequency characteristic domain along a channel dimension, and downsample the first relevant information to obtain encoded time series data, wherein the raw time series data comprises multiple types of raw vibration data, and each of the multiple channels collects a type of raw vibration data;
a decoding module configured to capture second relevant information of the encoded time series data along a time dimension, and upsample the second relevant information to obtain decoded time series data; and
a synthesizing module configured to synthesize the decoded time series data according to a trend and a time period respectively, and then perform concatenation processing to obtain the target time series data.

2. The industrial time series AIGC fundamental model according to claim 1, wherein the encoding module comprises:
a first convolution component configured to encode the raw time series data through multiple encoder layers to obtain first intermediate data, wherein the first intermediate data comprises encoded intermediate time series data, continuous time feature information, and vector condition information;
a cross-channel learning component configured to process the first intermediate data in the frequency characteristic domain along the channel dimension to obtain the first relevant information; and
a first sampling component configured to perform downsampling processing on the first relevant information to obtain the encoded time series data.

3. The industrial time series AIGC fundamental model according to claim 2, wherein the cross-channel learning component comprises:
a first frequency converter configured to convert the first intermediate data along a time step dimension to a frequency domain via fast Fourier transform to obtain a first query vector;
a second frequency converter, configured to perform fast Fourier transform on a product of the first intermediate data and a preset first key vector weight matrix to obtain a first key vector;
a third frequency converter configured to perform fast Fourier transform on a product of the first intermediate data and a preset first value vector weight matrix to obtain a first value vector;
a transposition module configured to transpose the first query vector, the first key vector, and the first value vector, respectively, to obtain a transposed second query vector, a transposed second key vector, and a transposed second value vector, respectively; and
a first capturer configured to capture the first relevant information in the frequency characteristic domain along the channel dimension according to the transposed second query vector, the transposed second key vector and the transposed second value vector.

4. The industrial time series AIGC fundamental model according to claim 3, wherein the first sampling component comprises:
a first frequency inverter configured to map the first relevant information back to a original time series domain via inverse fast Fourier transform to obtain first to-be-sampled time series data; and
a downsampling sub-component configured to perform downsampling processing on the first to-be-sampled time series data to obtain the encoded time series data.

5. The industrial time series AIGC fundamental model according to claim 4, wherein the decoding module comprises:
a second convolution component configured to decode the encoded time series data by multiple decoder layers to obtain second intermediate data; and
a cross-temporal learning component configured to process the second intermediate data along the time dimension to obtain the second relevant information of the encoded time series data; and
a second sampling component, configured to perform upsampling processing on the second relevant information to obtain the decoded time series data.

6. The industrial time series AIGC fundamental model according to claim 5, wherein the cross-temporal learning component comprises:
a fourth frequency converter configured to convert the second intermediate data along the time dimension to the frequency domain via fast Fourier transform to obtain a third query vector;
a fifth frequency converter, configured to perform fast Fourier transform on a product of the second intermediate data and a preset third key vector weight matrix to obtain a third key vector;
a sixth frequency converter configured to perform fast Fourier transform on a product of the second intermediate data and a preset third value vector weight matrix to obtain a third value vector; and
a second capturer configured to capture the second relevant information of the encoded time series data along the time dimension according to the third query vector, the third key vector and the third value vector.

7. The industrial time series AIGC fundamental model according to claim 6, wherein the second sampling component comprises:
a mask processor configured to perform adaptive high frequency mask processing on the third query vector to obtain a frequency enhancement parameter;
a second frequency inverter configured to map a sum of the second relevant information and the frequency enhancement parameter back to the original time series domain via inverse fast Fourier transform, to obtain second to-be-sampled time series data; and
an upsampling sub-component configured to perform upsampling processing on the second to-be-sampled time series data to obtain the decoded time series data.

8. The industrial time series AIGC fundamental model according to claim 7, wherein the mask processor comprises:
a spectrum calculating component configured to calculate a spectrum representing an intensity of each time series frequency according to the third query vector;
a filtering component configured to normalize the spectrum and filter out a frequency component which is below a preset training threshold to obtain a filtered spectrum; and
a frequency enhancing component configured to obtain a frequency enhancement parameter according to the filtered spectrum and a preset adaptive weight.

9. The industrial time series AIGC fundamental model according to claim 8, wherein the synthesizing module comprises:
a trend synthesizing component configured to synthesize the decoded time series data according to the trend to obtain a first time series feature matrix;
a seasonal synthesizing component configured to synthesize the decoded time series data according to the time period to obtain a second time series feature matrix;
a concatenating component configured to add the first time series feature matrix and the second time series feature matrix and then concatenate a result of the addition with the raw time series data to obtain concatenated time series data; and
a reconstructing component configured to perform deep processing and reconstruction on the concatenated time series data through a residual block, to obtain the target time series data, wherein the residual block consists of a multi-layer convolution operation and a non-linear activation function.

10. An electronic device, comprising a memory and a processor;
the memory stores a computer-executable instruction;
the processor executes the computer-executable instruction stored in the memory to:
capture first relevant information of the raw time series data in a frequency characteristic domain along a channel dimension, and downsample the first relevant information to obtain encoded time series data, wherein the raw time series data comprises multiple types of raw vibration data, and each of the multiple channels collects a type of raw vibration data;
capture second relevant information of the encoded time series data along a time dimension, and upsample the second relevant information to obtain decoded time series data; and
synthesize the decoded time series data according to a trend and a time period respectively, and then perform concatenation processing to obtain the target time series data.

11. The electronic device according to claim 10, wherein the processor executes the computer-executable instruction stored in the memory to:
encode the raw time series data through multiple encoder layers to obtain first intermediate data, wherein the first intermediate data comprises encoded intermediate time series data, continuous time feature information, and vector condition information;
process the first intermediate data in the frequency characteristic domain along the channel dimension to obtain the first relevant information; and
perform downsampling processing on the first relevant information to obtain the encoded time series data.

12. The electronic device according to claim 11, wherein the processor executes the computer-executable instruction stored in the memory to:
convert the first intermediate data along a time step dimension to a frequency domain via fast Fourier transform to obtain a first query vector;
perform fast Fourier transform on a product of the first intermediate data and a preset first key vector weight matrix to obtain a first key vector;
perform fast Fourier transform on a product of the first intermediate data and a preset first value vector weight matrix to obtain a first value vector;
transpose the first query vector, the first key vector, and the first value vector, respectively, to obtain a transposed second query vector, a transposed second key vector, and a transposed second value vector, respectively; and
capture the first relevant information in the frequency characteristic domain along the channel dimension according to the transposed second query vector, the transposed second key vector and the transposed second value vector.

13. The electronic device according to claim 12, wherein the processor executes the computer-executable instruction stored in the memory to:
map the first relevant information back to a original time series domain via inverse fast Fourier transform to obtain first to-be-sampled time series data; and
perform downsampling processing on the first to-be-sampled time series data to obtain the encoded time series data.

14. The electronic device according to claim 13, wherein the processor executes the computer-executable instruction stored in the memory to:
decode the encoded time series data by multiple decoder layers to obtain second intermediate data;
process the second intermediate data along the time dimension to obtain the second relevant information of the encoded time series data; and
perform upsampling processing on the second relevant information to obtain the decoded time series data.

15. The electronic device according to claim 14, wherein the processor executes the computer-executable instruction stored in the memory to:
convert the second intermediate data along the time dimension to the frequency domain via fast Fourier transform to obtain a third query vector;
perform fast Fourier transform on a product of the second intermediate data and a preset third key vector weight matrix to obtain a third key vector;
perform fast Fourier transform on a product of the second intermediate data and a preset third value vector weight matrix to obtain a third value vector; and
capture the second relevant information of the encoded time series data along the time dimension according to the third query vector, the third key vector and the third value vector.

16. The electronic device according to claim 15, wherein the processor executes the computer-executable instruction stored in the memory to:
perform adaptive high frequency mask processing on the third query vector to obtain a frequency enhancement parameter;
map a sum of the second relevant information and the frequency enhancement parameter back to the original time series domain via inverse fast Fourier transform, to obtain second to-be-sampled time series data; and
perform upsampling processing on the second to-be-sampled time series data to obtain the decoded time series data.

17. The electronic device according to claim 16, wherein the processor executes the computer-executable instruction stored in the memory to:
calculate a spectrum representing an intensity of each time series frequency according to the third query vector;
normalize the spectrum and filter out a frequency component which is below a preset training threshold to obtain a filtered spectrum; and
obtain a frequency enhancement parameter according to the filtered spectrum and a preset adaptive weight.

18. The electronic device according to claim 17, wherein the processor executes the computer-executable instruction stored in the memory to:
synthesize the decoded time series data according to the trend to obtain a first time series feature matrix;
synthesize the decoded time series data according to the time period to obtain a second time series feature matrix;
add the first time series feature matrix and the second time series feature matrix and then concatenate a result of the addition with the raw time series data to obtain concatenated time series data; and
perform deep processing and reconstruction on the concatenated time series data through a residual block, to obtain the target time series data, wherein the residual block consists of a multi-layer convolution operation and a non-linear activation function.

19. A non-transitory computer-readable storage medium, storing a computer-executable instruction;
a processor executes the computer-executable instruction to:
capture first relevant information of the raw time series data in a frequency characteristic domain along a channel dimension, and downsample the first relevant information to obtain encoded time series data, wherein the raw time series data comprises multiple types of raw vibration data, and each of the multiple channels collects a type of raw vibration data;
capture second relevant information of the encoded time series data along a time dimension, and upsample the second relevant information to obtain decoded time series data; and
synthesize the decoded time series data according to a trend and a time period respectively, and then perform concatenation processing to obtain the target time series data.
